(19) United States
(12) Patent Application Publication
(10) Pub. No.: US 2025/0164257 A1
(43) Pub. Date: May 22, 2025

(54) APPARATUS AND METHOD FOR SEARCHING FOR A ROUTE USING GEOSPATIAL EMBEDDING BASED ON DYNAMIC RESOLUTION

(71) Applicant: HYUNDAI AUTOEVER CORP., Seoul (KR)

(72) Inventors: Sangkyu Son, Seoul (KR); JeongHun Lee, Seoul (KR); WooSun Chon, Seoul (KR)

(73) Assignee: HYUNDAI AUTOEVER CORP., Seoul (KR)

(21) Appl. No.: 18/953,562

(22) Filed: Nov. 20, 2024

(30) Foreign Application Priority Data
Nov. 21, 2023 (KR) 10-2023-0162282

(51) Int. Cl. G01C 21/34; G06F 16/29

(52) U.S. Cl. CPC G01C 21/3446; G01C 21/3492; G06F 16/29

(57) ABSTRACT

An apparatus and a method for searching for a route using geospatial embedding based on dynamic resolution are disclosed. The apparatus includes a storage module configured to store digital map data. The apparatus further includes a processor configured to perform route search based on an estimated time of arrival (ETA) prediction model in response to a route search request. The ETA prediction model is configured to use a road network split into a plurality of tiles.

### CROSS-REFERENCE TO RELATED APPLICATION

This application claims the priority to and the benefit of Korean Patent Application No. 10-2023-0162282, filed on Nov. 21, 2023, the entire contents of which are incorporated herein by reference.

### TECHNICAL BACKGROUND

The present disclosure relates to an apparatus and a method for searching for a route using geospatial embedding based on dynamic resolution. More particularly, the present disclosure relates to a route search apparatus and a route search method for performing route search by splitting a large road network based on dynamic resolution and using the split networks to predict the estimated time of arrival (ETA).

### BACKGROUND

Recently, most of vehicles are equipped with navigation apparatuses. Furthermore, traffic jam frequently occurs at roads and intersections due to an increase of vehicles. Accordingly, although a user rides on a road that is already known, the user is commonly provided with guidance in order to check and avoid a section, such as a road or an intersection in which traffic jam occurs, by performing route search through navigation.

Furthermore, when performing the route search, the user basically uses the estimated time of arrival (ETA) information. For example, the user determines a departure time or an appointed time based on the ETA information. Accordingly, if the ETA is not accurate, the user determines the departure time or the appointed time by further adding a float time. If the ETA is accurate, the float time can be reduced, and this allows the user to save time without wasting the time on the road.

Accordingly, in the route search process using navigation, an optimal route and a recommended route are calculated by using the ETA.

As a deep learning-based information prediction technique is developed, research for a deep learning-based technique for more accurately predicting the ETA is actively carried out.

However, conventional techniques have a problem in that when the entire road network (e.g., a national network) is used, an actual road environment is not incorporated. For example, a country is expressed by cutting the country at predetermined intervals or the country is divided for each administrative district.

The subject matter described in this background section is intended to promote an understanding of the background of the disclosure and thus may include subject matter that is not already known to those of ordinary skill in the art.

### SUMMARY

The present disclosure is directed to providing an apparatus and a method for searching for a route using geospatial embedding based on dynamic resolution. The apparatus and the method may split a large road network based on dynamic resolution so that an actual road environment can be incorporated.

In an embodiment, an apparatus for searching for a route using geospatial embedding based on dynamic resolution includes a storage module configured to store digital map data. The apparatus further includes a processor configured to perform route search based on an estimated time of arrival (ETA) prediction model in response to a route search request. The ETA prediction model is configured to use a road network split into a plurality of tiles.

In an embodiment of the present disclosure, the ETA prediction model is further configured to use the road network split into the plurality of tiles by incorporating a number of links of a road.

In an embodiment of the present disclosure, the ETA prediction model is further configured to use the road network split into the plurality of tiles based on a maximum number of links that are able to be included in one tile.

In an embodiment of the present disclosure, the ETA prediction model is further configured to use a tree expanded by inserting all of the links of the road network into the tile and splitting the tile by a preset number when the number of links inserted into one tile is greater than the maximum number of links.

In an embodiment of the present disclosure, the ETA prediction model is further configured to use link information split and stored in a leaf node when the tree becomes the leaf node that is no longer expanded.

In an embodiment of the present disclosure, the ETA prediction model is further configured to use ID information assigned to each of the plurality of tiles that have been finally split so that the tree is no longer expanded.

In an embodiment of the present disclosure, the ETA prediction model is further configured to use, as an input value, ID information of a tile, among the plurality of the tiles, including a link according to the route search.

In an embodiment of the present disclosure, the processor is further configured to calculate a plurality of candidate routes in response to the route search request and calculate the ETA of each of the candidate routes through the ETA prediction model.

In an embodiment of the present disclosure, the processor is further configured to calculate a cost for each of the candidate routes based on the calculated ETA of each of the candidate routes.

In an embodiment, a method of generating an ETA prediction model includes inserting, by a processor, a road link of a road network into a tree. The method further includes expanding, by the processor, the tree by splitting a tile by a preset number when a number of links inserted into the tile of the tree is greater than a maximum number of links that are able to be included in one tile. The method further includes assigning, by the processor, ID information to each of the tiles that have been finally split so that the tree is no longer expanded. The method further includes training, by the processor, an ETA prediction model by using the ID information of the tile including a link according to a route having an ETA predicted as an input value.

In an embodiment of the present disclosure, training the ETA prediction model includes training, by the processor, the ETA prediction model by further using, as the input value, dynamic features including time information and traffic features including passage speed information of the link.

In an embodiment of the present disclosure, the method further includes outputting, by the ETA prediction model, a link passage time as an output value.

In an embodiment of the present disclosure, the method further includes outputting, by the ETA prediction model, an ETA of all of routes as an output value.

In an embodiment, a method of searching for a route using geospatial embedding based on dynamic resolution includes receiving, by a processor, a route search request. The method further includes performing, by the processor, route search based on an estimated time of arrival (ETA) prediction model. The method further includes providing, by the processor, results of the route search. The method further includes using, by the ETA prediction model, a road network split into a plurality of tiles.

In an embodiment of the present disclosure, performing the route search includes calculating, by the processor, a plurality of candidate routes in response to the route search request. Performing the route search also includes calculating, by the processor, the ETA of each of the candidate routes through the ETA prediction model.

In an embodiment of the present disclosure, performing the route search further includes calculating, by the processor, a cost for each of the candidate routes based on the calculated ETA of each of the candidate routes.

In an embodiment of the present disclosure, the method further includes training, by the processor, the ETA prediction model by using ID information of a tile, among the plurality of the tiles, including a link according to a route having an ETA predicted as an input value, before receiving the route search request.

In an embodiment of the present disclosure, the method further includes using, by the ETA prediction model, the road network split into the plurality of tiles based on a maximum number of links that are able to be included in one tile.

In an embodiment of the present disclosure, the method further includes using, by the ETA prediction model, a tree expanded by inserting all of the links of the road network into the tile and splitting the tile by a preset number when a number of links inserted into one tile is greater than the maximum number of links.

In an embodiment of the present disclosure, the method further includes using, by the ETA prediction mode, link information split and stored in a leaf node when the tree becomes the leaf node that is no longer expanded.

The apparatus and the method for searching for a route using geospatial embedding based on dynamic resolution according to the embodiments of the present disclosure have an effect in that computer resources can be reduced by reducing the unnecessary use of data because a road network is split into a plurality of tiles based on dynamic resolution.

### BRIEF DESCRIPTION OF THE DRAWINGS

FIG. 1 is a diagram illustrating a schematic construction of an apparatus for searching for a route using geospatial embedding based on dynamic resolution according to an embodiment of the present disclosure.

FIG. 2 is a flowchart for describing geospatial embedding based on dynamic resolution in the apparatus for searching for a route using geospatial embedding based on dynamic resolution according to an embodiment of the present disclosure.

FIG. 3 is a diagram for describing a dynamic tile split method in the apparatus for searching for a route using geospatial embedding based on dynamic resolution according to an embodiment of the present disclosure.

FIG. 4 is a diagram for describing a static tile split method for route search.

FIG. 5 is a diagram for describing an estimated time of arrival (ETA) prediction model of the apparatus for searching for a route using geospatial embedding based on dynamic resolution according to an embodiment of the present disclosure.

FIG. 6 is a flowchart for describing a method of searching for a route using geospatial embedding based on dynamic resolution according to an embodiment of the present disclosure.

FIG. 7 is a flowchart for describing the use of the ETA prediction model in the method of searching for a route using geospatial embedding based on dynamic resolution according to an embodiment of the present disclosure.

### DETAILED DESCRIPTION

Hereinafter, an apparatus and a method for searching for a route using geospatial embedding based on dynamic resolution according to embodiments of the present disclosure are described with reference to the accompanying drawings. In this process, the thicknesses of lines or the sizes of components illustrated in the drawings may have been exaggerated for the clarity of a description and for convenience' sake. Terms to be described below have been defined by taking into consideration their functions in the present disclosure and may be changed depending on a user or operator's intention or practice. Accordingly, such terms should be defined based on the overall contents of the present disclosure. When a controller, module, component, device, element, or the like of the present disclosure is described as having a purpose or performing an operation, function, or the like, the controller, module, component, device, element, or the like should be considered herein as being “configured to” meet that purpose or to perform that operation or function. Each controller, module, component, device, element, and the like may separately embody or be included with a processor and a memory, such as a non-transitory computer readable media, as part of the apparatus.

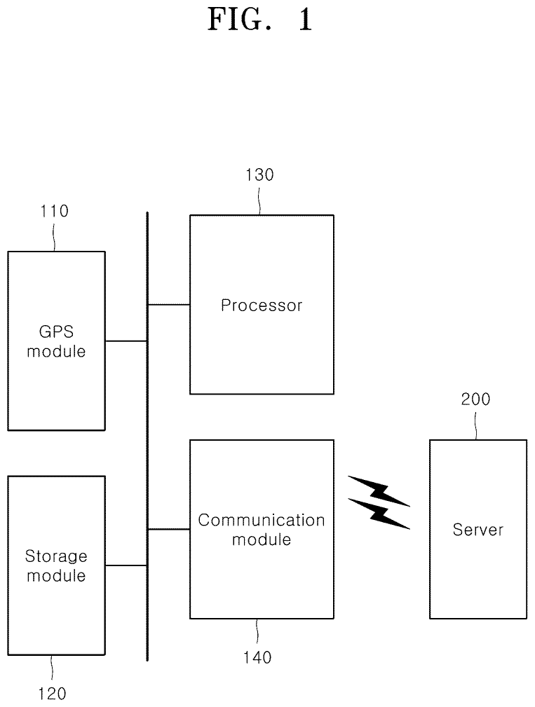

FIG. 1 is a diagram illustrating a schematic construction of an apparatus for searching for a route using geospatial embedding based on dynamic resolution according to an embodiment of the present disclosure.

As illustrated in FIG. 1, the apparatus for searching for a route using geospatial embedding based on dynamic resolution according to the present embodiment includes a global positioning system (GPS) module 110, a storage module 120, a processor 130, and a communication module 140.

The GPS module 110 receives a GPS signal for detecting the current location of a vehicle and also receives information on the current location of a navigation apparatus by using the GPS module.

Furthermore, the GPS module 110 may receive traffic (or traffic volume) information and vehicle traffic information for each link, lane information for each road, and traffic situation information (e.g., an accident, an event, or construction) through a real-time traffic information reception module (not illustrated) or the communication module 140.

Internal memory (or a database) of the processor 130 stores digital map data (e.g., precision map data and a high definition (HD) map). The digital map data includes geographic coordinates that express latitude and longitude in a degree/minute/second unit.

The storage module 120 stores link information based on the digital map data and may store a traffic information history for each link that is received through the communication module 140.

The storage module 120 may store a real-time traffic information history for each link by season, by day, and by hour.

In this case, the storage module 120 may store the real-time traffic information history for each link in a server 200 while operating in conjunction with the server 200 or may also store a real-time traffic information history during a predetermined period (e.g., a designated predetermined period) (e.g., one year).

Accordingly, hereinafter, information that is stored in the storage module 120 should be understood as including information stored in the server 200.

The processor 130 may perform learning (e.g., deep learning) by incorporating information (e.g., real-time traffic information for each link and information on the attributes (e.g., the number of lanes, whether a signal is present or not, the number of turns, and collection trajectory, and a traffic information history) of a road) that is stored in the storage module 120.

The processor 130 may include a route search engine (e.g., a route search algorithm) and an estimated time of arrival (ETA) prediction model (e.g., a deep learning model for ETA prediction).

The processor 130 may calculate (or compute) a plurality of candidate routes through the route search engine and may calculate (or compute) an optimal route, among the candidate routes, through the ETA prediction model.

The processor 130 may calculate a more accurate optimal route when performing route search through the ETA prediction model that uses dynamic resolution-based geospatial embedding.

The communication module 140 communicates with the server 200 (e.g., an ETA prediction server, a cloud server, or a navigation server).

The apparatus for searching for a route using geospatial embedding based on dynamic resolution according to the present embodiment includes a navigation terminal (not illustrated) installed in a vehicle and at least one external server 200 (e.g., a navigation server, a cloud server, or an ETA prediction server) that is connected to the navigation terminal through communication.

For example, the apparatus for searching for an optimal route based on all of routes according to the present embodiment may provide guidance by calculating a plurality of candidate routes by using at least one information (e.g., real-time traffic information, ETA prediction information, and cost information) that is provided to the server 200 in the state in which the optimal route search apparatus based on all of routes has been connected to the server 200 through communication. Alternatively, the apparatus may use at least one information (e.g., real-time traffic information, ETA prediction information, and cost information) that is provided by the server 200. The apparatus may provide guidance by calculating (or computing) an optimal route (i.e., an optimal candidate route having the smallest cost), among the plurality of candidate routes.

Alternatively, in some embodiments, the apparatus according to the present embodiment may be constructed in a form in which the server 200 receives a route search request from a navigation terminal that is installed in a vehicle, calculates an optimal route into which the ETA of all of routes has been incorporated, and provides the optimal route to the navigation terminal.

Furthermore, the server 200 is equipped with a computation apparatus, such as a processor, and performs such a route search operation. Accordingly, an operation by the server 200 may also be described as being performed by the processor.

The ETA prediction model produces a dimension tree that is obtained by dividing a road network in a road link unit, subdivides the dimension tree, and then uses the value of a corresponding dimension tree as a geospatial feature value through embedding. When a large road network is expressed as described above, the limit of an unnecessary geographical expression can be overcome and a finer road network can be expressed by dynamically expressing only a road.

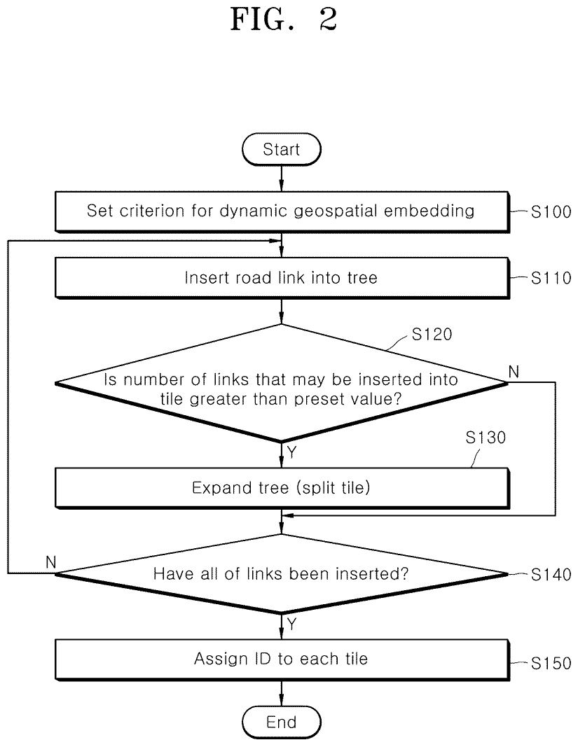

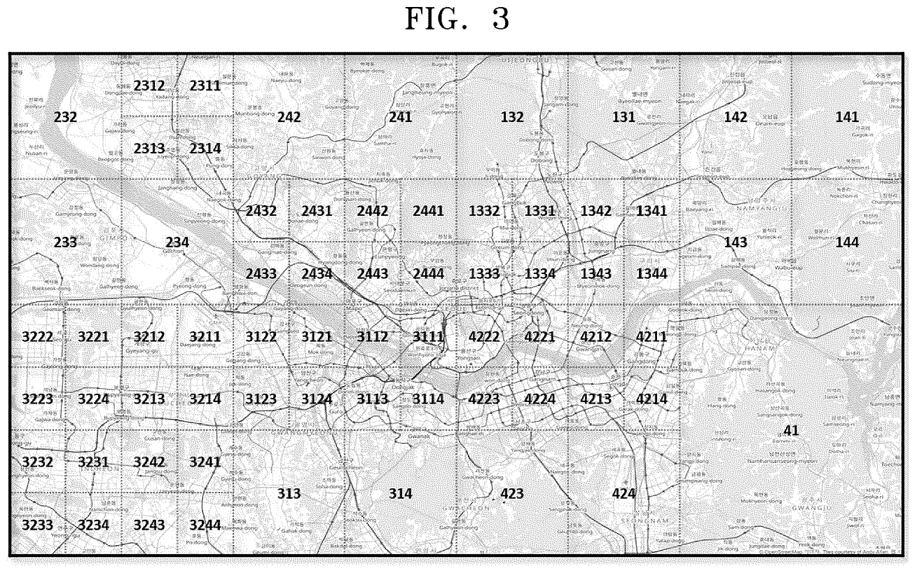

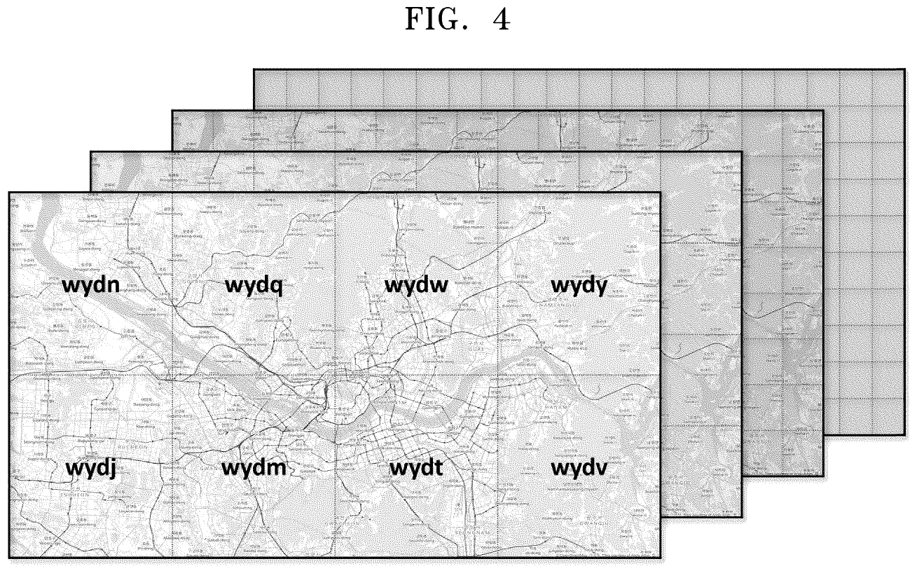

FIG. 2 is a flowchart for describing geospatial embedding based on dynamic resolution in the apparatus for searching for a route using geospatial embedding based on dynamic resolution according to an embodiment of the present disclosure. FIG. 3 is a diagram for describing a dynamic tile split method in the apparatus for searching for a route using geospatial embedding based on dynamic resolution according to an embodiment of the present disclosure. FIG. 4 is a diagram for describing a static tile split method for route search.

Referring to FIG. 2, a criterion for dynamic geospatial embedding is set (S100). In other words, in the dynamic geospatial embedding (e.g., a tile split method based on dynamic resolution or a road network split algorithm), a maximum number of links (e.g., 500) per tile (or may also be denoted as a cell) and the number (e.g., 4) of splits of a tile may be set as preset values. The preset value may be set through an input from a user.

In this case, the number (e.g., 500) of links or the number (e.g., 4) of slits of the tile, which are set as the preset values, are merely exemplary values, and the present disclosure is not limited thereto.

Furthermore, in the repetitive operation of the present geospatial embedding based on dynamic resolution, it is assumed that the whole country (e.g., the Korean Peninsula) is first set as one tile coordinate.

Thereafter, the processor 130 inserts a road link into a tree (S110). In general, road information includes a node and a link. The node means a nodal point (e.g., an intersection) of the road. The link means a road line that connects such nodes.

For example, as described above, the link is inserted into one tile that has been set in the whole country (e.g., the Korean Peninsula).

The processor 130 determines whether the number of links inserted into the tile is greater than the number of links that may be included in the tile (S120). The processor 130 expands the tree by splitting the tile (S130) when the number of links inserted into the tile is greater than the number of links that may be included in the tile (YES in S120). In other words, in the tree, when the number of links inserted into the tile is greater than the preset value (e.g., 500), the tree is expanded by splitting the tile based on the number (e.g., 4) of slits of the tile.

For example, it may be understood that the expansion of the tree in which the tile is split into 4 includes internally reducing one tile including the number of links greater than the preset value to four small tiles.

For example, as illustrated in FIG. 3, a tree may be expanded in a way that one tile is split as a fourth quadrant.

The processor 130 determines whether all of the links have been inserted (S140). When not all of the links have been inserted, the processor 130 (NO in S140), the processor 130 inserts all of the links into the tree by repeating steps S110, S120, and S130 until all of the links are inserted into the tree.

When all of the links are inserted into the tree (YES in S140), the processor 130 assigns an ID to each of the tiles that have been finally split (S150).

In other words, when the tree continues to be expanded and is no longer expanded and becomes a leaf node, data (e.g., a link) are split at the leaf node.

In other words, this means that when one large tile is internally reduced to four small tiles and finally reduced to the smallest tile, data (e.g., a link) are split at the smallest tile.

Furthermore, the processor 130 assigns the ID to each of the tiles that have been finally split so that the ETA prediction model can use corresponding geospatial information in route search.

Referring to FIG. 3, it may be seen that a tile at a location (e.g., a downtown area) at which the links of a road network are crowded for each area is reduced to a minimum (i.e., the number of links included in the tile is reduced to 500 or less) and a tile at a location (e.g., in the outskirts of a city) at which the links of a road network are not crowded for each area has a relatively large size.

In other words, a road network is produced in a link unit, and only one sheet of the road network having various types of resolution is expressed because resolution of a section in which roads are crowded is deepened and resolution of a section in which roads are not crowded becomes shallow.

Static road network expression, as described with reference to FIG. 4, is a method of expressing the entire area to be embedded with designated resolution by constantly splitting the entire area into latitude and longitude. In the static road network expression, the entire road network may be expressed with desired resolution within a short time. However, the static road network expression has problems in that unnecessary data not including a road are generated if a static split is performed in a predetermined size and multiple pieces of resolution need to be used together in order to receive information on a part including a major road.

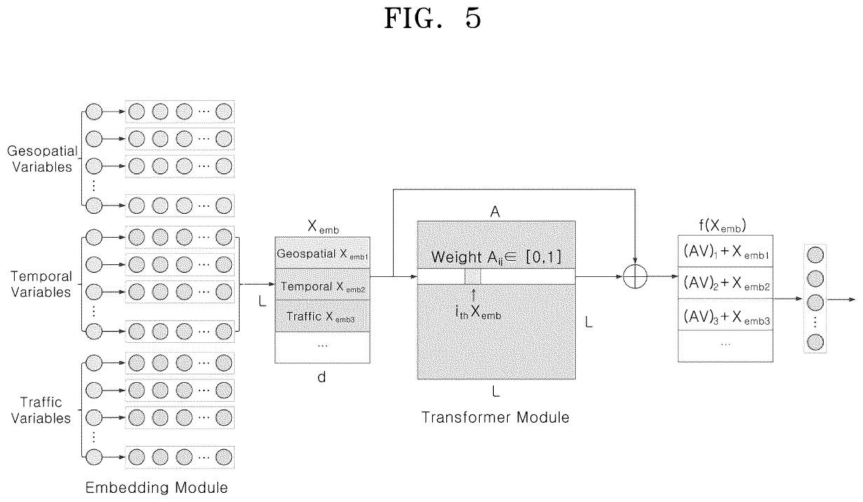

FIG. 5 is a diagram for describing the ETA prediction model of the apparatus for searching for a route using geospatial embedding based on dynamic resolution according to an embodiment of the present disclosure.

The geospatial information based on dynamic resolution, which has been expressed as described above, may be used in ETA calculation by being used in the ETA prediction model to be described below.

Referring to FIG. 5, the structure of the ETA prediction model may be a linear model comprising an embedding module and a transformer module.

In the embedding module, categorical data is embedded in a d-dimension size. Continuous data may be bucketized and then embedded in a d-dimension size. In this case, the bucketizing means that the continuous data are converted into several features by splitting the continuous data into predetermined sections.

Temporal features, geospatial features, and situational features may be used as the categorical data. Traffic information features and distance information features may be used as the continuous data.

For example, the ETA prediction model (e.g., a deep learning model for ETA prediction) according to an embodiment of the present disclosure may use, as input values, dynamic features (e.g., day of the week, time zone of the day (e.g., a 5-minute unit), or time zone of the week) including time information, geospatial features (e.g., a source ID, a destination ID, and a source ID-destination ID) including ID information of a tile to which the dynamic tile split method has been applied, traffic features including passage speed information (e.g., a real-time link passage speed or a past link passage speed) of a link, context features including source and destination information, and distance features including length information of a route.

In addition, each link type, each road type, a link length, event (e.g., an accident or construction) information, the link passage time of the route search engine, and ETA information of the route search engine may be further used as the input values.

The transformer module may consist of a linear transformer having a smaller computational load than a common transformer structure and a fully connected layer.

The ETA prediction model may learn location information on where each link is located, and the ETA prediction model may learn the importance of a link according to a road situation through an attention matrix. Different weights (i.e., a higher weight is assigned to important features) may be assigned between input features.

A No. i-th line of an LXL attention matrix of the linear transformer may be calculated as in Equation 1. In this case, a Kernel function φ(·) is φ(x)=elu(x)+1=max(α(e^{x}−1),0)+1. An attention value V′ may be incorporated through a residual connection like f(X_{emb})=V′+X_{emb}.

$${V}_{i}^{′} = \frac{{\sum }_{j = 1}^{L} {φ ( {Q}_{i} )}^{T} φ ( {K}_{j} ) {V}_{j}}{{\sum }_{j = 1}^{L} {φ ( {Q}_{i} )}^{T} φ ( {K}_{j} )} = \frac{{φ ( {Q}_{i} )}^{T} {\sum }_{j = 1}^{L} φ ( {K}_{j} ) {V}_{j}}{{φ ( {Q}_{i} )}^{T} {\sum }_{j = 1}^{L} φ ( {K}_{j} )} \qquad ( 1 )$$

The output value of the ETA prediction model may be the ETA value and/or link passage time of all of routes. In other words, the ETA value of all of the routes may be directly predicted or the passage time of each link of all of the routes may be predicted. In the latter case, the sum of values of the link passage time may be used as an ETA prediction value.

However, the ETA prediction model according to an embodiment of the present disclosure may be implemented in various ways in which geospatial features using the aforementioned dynamic resolution embedding method are used as the input values.

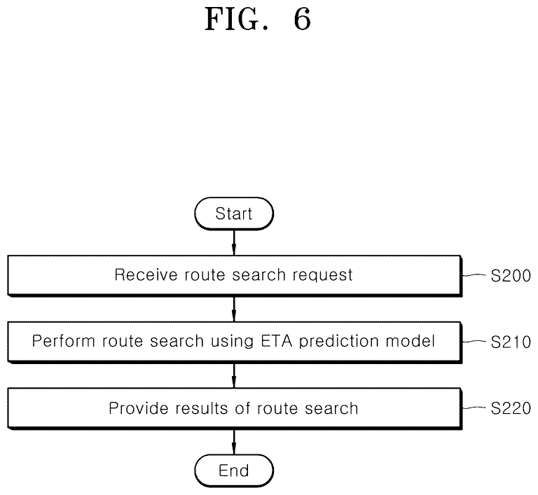

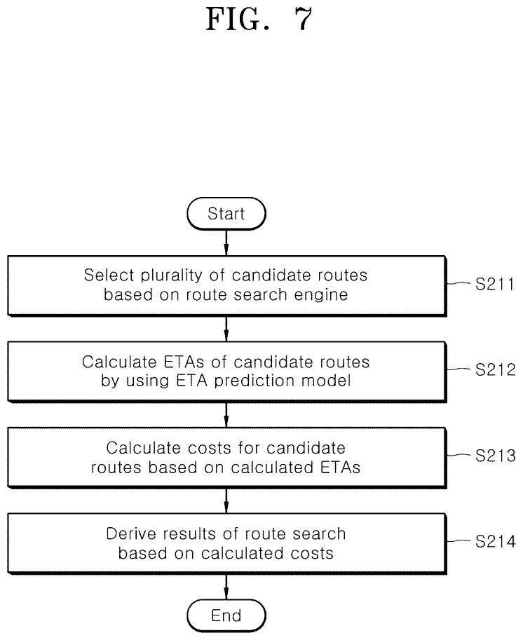

FIG. 6 is a flowchart for describing a method of searching for a route using geospatial embedding based on dynamic resolution according to an embodiment of the present disclosure. FIG. 7 is a flowchart for describing the use of the ETA prediction model in the method of searching for a route using geospatial embedding based on dynamic resolution according to an embodiment of the present disclosure.

As illustrated in FIG. 6, the processor 130 receives a route search request (S200). For example, the processor 130 may receive a route search request, including source information, destination information, and departure time information, from a user through the input module of a navigation apparatus.

Thereafter, the processor 130 performs route search using the ETA prediction model (S210).

In general, such an operation for route search operates based on the route search engine. The route search engine may search for a route from a source to a destination based on source information, destination information, and departure time information and may select and output a candidate route that is suitable for various conditions (e.g., the shortest distance, the shortest time, and preference to a free road). However, the route search engine is already widely used in the technical field of the present disclosure, and a further description thereof is omitted.

Accordingly, as illustrated in FIG. 7, the processor 130 selects a plurality of candidate routes based on the route search engine (S211). In this case, the selection of the candidate routes based on the route search engine may be performed in a way to calculate a cost for each link and may calculate the candidate routes in order of a lower sum cost. In this case, the cost for the link is a concept in which the cost that is used to pass through the link has been digitized, and the cost for the link may be calculated by considering the length of the link and an expected passage time of the link. Furthermore, the final cost for a corresponding route may be calculated by predicting the ETA of the candidate route and incorporating the predicted ETA into the cost.

However, a detailed method of calculating the cost for the search route may be different depending on a user's intention, the design of a navigation system, etc.

In this case, the route search engine basically uses the ETA in calculating the candidate route. In some embodiments, the route search engine may be constructed to calculate the candidate route by including the ETA prediction model according to the embodiment of the present disclosure in the route search engine.

Alternatively, as described below, the route search engine selects the candidate route according to a conventional method but may use a method of calculating the cost again by additionally performing ETA prediction using the ETA prediction model according to the embodiment of the present disclosure.

Accordingly, the processor 130 calculates the ETAs of the candidate routes by using the ETA prediction model according to the embodiment of the present disclosure (S212). Next, the processor 130 calculates the costs for the candidate routes based on the calculated ETAs (S213).

Thereafter, the processor 130 derives the results of the route search based on the calculated costs (S214). In other words, the processor 130 may calculate the costs again based on the calculated ETAs of the candidate route and may then align the candidate routes in order of lower (or smaller) costs.

Next, the processor 130 provides the results of the route search (S220). That is, the processor 130 may provide a user with a list of the candidate routes and each ETA as the results of the route search.

Although embodiments of the disclosure have been disclosed for illustrative purposes, those having ordinary skill in the art should appreciate that various modifications, additions and substitutions are possible, without departing from the scope and spirit of the present disclosure as defined in the accompanying claims. Thus, the true technical scope of the disclosure should be defined by the following claims.

What is claimed is:

1. An apparatus for searching for a route using geospatial embedding based on dynamic resolution, the apparatus comprising:
a storage module configured to store digital map data; and
a processor configured to perform route search based on an estimated time of arrival (ETA) prediction model in response to a route search request,
wherein the ETA prediction model is configured to use a road network split into a plurality of tiles.

2. The apparatus of claim 1, wherein the ETA prediction model is further configured to use the road network split into the plurality of tiles by incorporating a number of links of a road.

3. The apparatus of claim 2, wherein the ETA prediction model is further configured to use the road network split into the plurality of tiles based on a maximum number of links that are able to be included in one tile.

4. The apparatus of claim 3, wherein the ETA prediction model is further configured to use a tree expanded by inserting all of the links of the road network into the tile and splitting the tile by a preset number when the number of links inserted into one tile is greater than the maximum number of links.

5. The apparatus of claim 4, wherein the ETA prediction model is further configured to use link information split and stored in a leaf node when the tree becomes the leaf node that is no longer expanded.

6. The apparatus of claim 4, wherein the ETA prediction model is further configured to use ID information assigned to each of the plurality of tiles that have been finally split so that the tree is no longer expanded.

7. The apparatus of claim 1, wherein the ETA prediction model is further configured to use, as an input value, ID information of a tile, among the plurality of the tiles, comprising a link according to the route search.

8. The apparatus of claim 1, wherein the processor is further configured to:
calculate a plurality of candidate routes in response to the route search request; and
calculate an ETA of each of the candidate routes through the ETA prediction model.

9. The apparatus of claim 8, wherein the processor is further configured to calculate a cost for each of the candidate routes based on the calculated ETA of each of the candidate routes.

10. A method of generating an estimated time of arrival (ETA) prediction model, the method comprising:
inserting, by a processor, a road link of a road network into a tree;
expanding, by the processor, the tree by splitting a tile by a preset number when a number of links inserted into the tile of the tree is greater than a maximum number of links that are able to be included in one tile;
assigning, by the processor, ID information to each of the tiles that have been finally split so that the tree is no longer expanded; and
training, by the processor, an ETA prediction model by using the ID information of the tile comprising a link according to a route having an ETA predicted as an input value.

11. The method of claim 10, wherein training the ETA prediction model comprises:
training, by the processor, the ETA prediction model by further using, as the input value, dynamic features comprising time information and traffic features comprising passage speed information of the link.

12. The method of claim 10, further comprising:
outputting, by the ETA prediction model, a link passage time as an output value.

13. The method of claim 10, further comprising:
outputting, by the ETA prediction model, an ETA of all of routes as an output value.

14. A method of searching for a route using geospatial embedding based on dynamic resolution, the method comprising:
receiving, by a processor, a route search request;
performing, by the processor, route search based on an estimated time of arrival (ETA) prediction model;
providing, by the processor, results of the route search; and
using, by the ETA prediction model, a road network split into a plurality of tiles.

15. The method of claim 14, wherein performing the route search comprises:
calculating, by the processor, a plurality of candidate routes in response to the route search request; and
calculating, by the processor, an ETA of each of the candidate routes through the ETA prediction model.

16. The method of claim 15, wherein performing the route search further comprises calculating, by the processor, a cost for each of the candidate routes based on the calculated ETA of each of the candidate routes.

17. The method of claim 14, further comprising:
training, by the processor, the ETA prediction model by using ID information of a tile, among the plurality of the tiles, comprising a link according to a route having an ETA predicted as an input value, before receiving the route search request.

18. The method of claim 17, further comprising:
using, by the ETA prediction model, the road network split into the plurality of tiles based on a maximum number of links that are able to be included in one tile.

19. The method of claim 18, further comprising:
using, by the ETA prediction model, a tree expanded by inserting all of the links of the road network into the tile and splitting the tile by a preset number when a number of links inserted into one tile is greater than the maximum number of links.

20. The method of claim 19, further comprising:
using, by the ETA prediction model, link information split and stored in a leaf node when the tree becomes the leaf node that is no longer expanded.
